(19) United States
(12) Patent Application Publication
(10) Pub. No.: US 2007/0056952 A1
(43) Pub. Date: Mar. 15, 2007

(54) Heating unit and wafer prober having the same

(76) Inventors: Katsuhiro Itakura, Itami-shi (JP); Masuhiro Natsuhara, Itami-shi (JP); Tomoyuki Awazu, Itami-shi (JP); Hirohiko Nakata, Itami-shi (JP)

Correspondence Address: MCDERMOTT WILL & EMERY LLP, 600 13TH STREET, N.W., WASHINGTON, DC, 20005-3096, US

(21) Appl. No.: 11/496,711

(22) Filed: Aug. 1, 2006

(30) Foreign Application Priority Data
Aug. 1, 2005 (JP) 2005-222492 (P)

(51) Int. Cl. H05B 3/68

(52) U.S. Cl. 219/444.1

(57) ABSTRACT

A heater unit that can be fabricated in a simple manner and is highly reliable, as well as a wafer prober mounting the heater unit are provided. The heater unit of the present invention includes a mounting base mounting an object to be processed and a heater unit heating the mounting base, wherein the heater body has an insulating sheet and a heating body formed on the insulating sheet. Preferably, at least a part of the heating body is covered with a protective layer, and preferably, the material of the heating body is metal foil. Further, preferably, the material of the protective layer is heat-resistant rubber, and preferably, the material of the insulating sheet is heat-resistant resin.

### BACKGROUND OF THE INVENTION

1. Field of the Invention

The present invention relates to a heater unit mounting and heating an object to be processed and, more specifically, to a heater unit used for a wafer prober in which the object to be processed is a semiconductor wafer, a base for mounting is a chuck top and a probe card is pressed to the wafer for inspecting electric characteristics of the wafer, as well as to a wafer prober including the heater unit.

2. Description of the Background Art

Conventionally, various wafer probers have been proposed as apparatuses for inspecting semiconductors. By way of example, Japanese Patent Laying-Open No. 2001-033484 proposes a wafer prober having a ceramic substrate that is thin but having high rigidity and is not susceptible to deformation with a thin metal layer formed on its surface, in place of a thick metal plate, to be less susceptible to deformation and to have smaller thermal capacity. According to this reference, the wafer prober has high rigidity and therefore it does not cause contact failure, and as it has small thermal capacity, it allows heating and cooling of the wafer in a short period of time. It is described that as a support base for mounting the wafer prober, an aluminum alloy or stainless steel may be used.

According to the method of Japanese Patent Laying-Open No. 2001-033484, however, after screen printing using metal paste, sintering in a prescribed atmosphere at a prescribed temperature is performed for forming a heating body. This method has a major problem that the steps of printing and sintering lead to relatively high cost, and it further has a problem that the formed heating body has much variation in resistance value and temperature of the chuck top tends to be uneven.

### SUMMARY OF THE INVENTION

The present invention was made to solve the above-described problems. Specifically, an object of the present invention is to provide a heater unit that can be fabricated in a simple manner and is highly reliable, as well as to provide a wafer prober including the same.

The heater unit in accordance with the present invention includes a mounting base mounting an object to be processed, and a heater body heating the mounting base, characterized in that the heater body has an insulating sheet and a heating body formed on the insulating sheet. In the present invention, preferably, at least a part of the heating body is covered with a protective layer, and preferably, the material of the heating body is metal foil.

It is preferred that the material of the protective layer is heat-resistant rubber. Further, it is preferred that the material of the insulating sheet is heat-resistant resin.

Preferably, the heater unit is a wafer heater unit.

The present invention also relates to a wafer prober including the heater unit.

The wafer prober including the heater unit as described above is low cost and highly reliable.

Namely, according to the present invention, a highly reliable heater unit that can be fabricated in a simple manner as well as a wafer prober including the unit can be provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1 and 2 are cross-sectional views showing exemplary cross-sectional structures of the heater unit in accordance with the present invention.

FIG. 3 is a cross-sectional view showing an example of a cross-sectional structure of an electrode portion in the heater unit in accordance with the present invention.

FIG. 4 is a cross-sectional view showing an example of a cross-sectional structure of the heater unit in accordance with the present invention.

FIGS. 5 and 6 are plan views showing examples of the supporter in accordance with the present invention.

FIGS. 7 to 9 are cross-sectional views showing exemplary cross-sectional structures of the heater unit in accordance with the present invention.

### DESCRIPTION OF THE PREFERRED EMBODIMENTS

The heater unit in accordance with the present invention includes a mounting base for mounting an object to be processed, and a heater body for heating the mounting base. The heater body includes an insulating sheet and a heating body formed on the insulating sheet, and typically, it consists of the insulating sheet and the heating body formed on the insulating sheet. It is preferred that the insulating sheet used in the present invention is heat-resistant, as it is used in combination with the heating body, and as the material of the insulating sheet, a heat-resistant resin is preferably used. As the heat-resistant resin, various resins such as polyimide, phenol resin or epoxy resin may be used, and polyimide is particularly preferred as it has good strength even when thickness thereof is made relatively thin. Though the thickness of the insulating sheet is not specifically limited, 20 μm or more is preferred. If the thickness were smaller than 20 μm, the strength of the insulating sheet would decrease, possibly causing a problem that the insulating sheet would be torn while handling the heating body formed on the insulating sheet. There is no specific upper limit of the thickness of insulating sheet, and it may be set, for example, to about 1 mm.

As the heating body used in the present invention, by way of example, metal foil is preferable. As the material of the metal foil, one that functions as a resistance heating body is preferred, and metal foil formed of stainless steel, nichrome, tungsten, molybdenum or the like may be used. Such metal foil is particularly preferred as its surface is not much susceptible to oxidation and its resistance value hardly varies, even when used at a high temperature. It is also possible to provide heat-resistant plating of nickel, gold, silver or the like on such metal foil. The thickness of the metal foil is not specifically limited, and at least 1 μm is preferred. Further, it is possible to control resistance value by adjusting the thickness of the metal foil.

As the method of forming the metal foil described above, rolling or other method may be used, and when a particularly thin metal foil is to be used, a method of forming a film directly on the insulating sheet by sputtering or vapor deposition may be used.

Further, the metal foil may be etched to form a pattern, thereby to form the heating body. As the method of etching, by way of example, polyimide may be applied to a prescribed thickness on a metal foil, and cured at about 200 to 300° C., so that the metal foil can be adhered on the insulating sheet. Then, photo-sensitive resin is applied to the surface of the metal foil and the heating body pattern may be exposed and developed to form the heating body. Alternatively, metal foil may be formed by sputtering or vapor deposition as described above on an insulating sheet of a prescribed thickness, and exposed and developed in the similar manner, so that the heating body is formed. Naturally, metal foil having a prescribed thickness and an insulating layer may be laminated, exposed and developed, to form the heating body.

It is preferred that the heating body formed in the above-described manner has at least a portion covered with a protective layer. The protective layer functions to ensure insulation when the heater body is used, to ensure insulation when the mounting base is electrically conductive, to ensure insulation of the heating body itself, and to ensure tight contact between the mounting base and the heater body. Typically, the protective layer is formed to be interposed between the mounting base and the heater body.

In view of the objects described above, it is preferred that the material of the protective layer is insulating. One having some flexibility is particularly preferred, as it can satisfactorily ensure tight contact between the mounting base and the heater body. Preferable materials of the protective layer include heat-resistant rubber and flexible silicone resin.

When heat-resistant rubber is used as the protective layer and the heater body obtained by forming the heating body on an insulating layer is to be attached to the mounting base, by way of example, the contact surface between the mounting base and the heater body may be covered with the heat-resistant rubber and the mounting base and the heater body are brought into tight contact with the heat-resistant rubber interposed, whereby the heater body can be attached on the mounting base. The contact surface of the heater body to the mounting base may be on the side of the heating body or on the side of the insulating sheet. Further, in the present invention, the protective layer may be formed on both surfaces of the heater body, that is, on the surface on the heating body side and on the surface on the insulating sheet side. When the heating body is covered by the protective layer in this manner, uniform contact between the heater body and the mounting base can be attained. In this case, preferably, at least that portion of the protective layer which is interposed between the mounting base and the heater body should be formed particularly uniformly.

Use of a flexible substance as the protective layer is advantageous in the following point. Specifically, when the heater body generates heat in the heater unit of the present invention, the heating body formed, for example, of metal foil and the insulating sheet thermally expand. Further, the mounting base also thermally expands. At the time of cooling, each of these starts to contract. Here, the heating body, the insulating sheet and the mounting base are formed of different materials, and therefore, the materials forming these components have different thermal expansion coefficients and different temperatures. When a flexible protective layer is used, thermal stress generated among the materials described above can be advantageously absorbed.

Though the thickness of the protective layer is not specifically limited, at most 1 mm is preferred. When the thickness of the protective layer exceeds 1 mm, high thermal resistance tends to generate between the heater body and the mounting base, as the protective layer itself has low thermal conductivity. In that case, energy loss possibly increases, and controllability would deteriorate, as it takes long time until the temperature of the mounting base increases when the heating body generates heats. It is preferred that the thickness of the protective layer is at least 10 μm. When the thickness of the protective layer is smaller than 10 μm, the difference in thermal expansion coefficient between the heater body and the mounting base cannot be fully absorbed by the protective layer serving as an adhesive layer when the protective layer is formed between the mounting base and the heater body, and the protective layer may possibly be separated from the mounting base when temperature cycles of heating and cooling are repeated. Therefore, preferable thickness of the protective layer is from about 10 μm to about 1 mm. It is particularly preferred that the thickness is from about 50 μm to about 300 μm, as good response of the mounting base to the temperature elevation of the heater body can be realized and the difference in thermal expansion coefficient between the heater body and the mounting base can sufficiently be absorbed.

In the present invention, by forming the heating body on the insulating sheet, the heating body can be fixed on the insulating sheet. In this case, the following advantage can be attained. Specifically, when the heating body is formed by etching metal foil or the like, it is difficult after etching the heating body to fix the heat generating bodies while maintaining a prescribed interval therebetween. When the heating body is fixed on the insulating sheet, however, the above-described problem is not likely, and the heating body pattern as designed can be formed.

Further, when the heating body is not formed on the insulating sheet and the heating body is fixed, by way of example, by a protective layer on the mounting base, typically, the heating body is fixed on the mounting base by applying a prescribed pressure, while the protective layer is heated. At this time, when the pressure applied during the fixing operation is released at the end of the fixing operation, it is possible that the interval between the heating bodies varies or, in the worst case, disconnection of the heating body occurs, because of the difference in thermal expansion coefficient among the mounting base, the protective layer having the function of an adhesive layer and the heating body, and because of deformation experienced as the protective layer is released from the pressure. In the present invention, however, the heating body is fixed on the insulating sheet as the heating body is formed on the insulating layer, and thus, the above-described problem can be solved.

Further, in the present invention, it is possible to form an adhesive layer on the heating body formed on the insulating sheet, and to form an insulating protective layer further thereon. The insulating layer may also serve as the protective layer. Specifically, in that case, it follows that the heating body is formed sandwiched by the insulating layer. When the heater body obtained by forming the heating body on the insulating sheet is adhered by the adhesive layer to the mounting base, by using the surface having the heating body formed thereon as the contact surface to the mounting base, the insulating sheet comes to serve as the protective layer. In that case, even when the mounting base is formed of a conductive material, insulation can be ensured between the mounting base and the heating body, as the adhesive layer and the insulating sheet exist between the mounting base and the heating body.

As another approach, in the structure formed in the above-described manner, a protective sheet may be formed further on the insulating sheet. In this case, assuming that a cooling module or the like is brought into contact from the surface opposite to the surface facing the mounting base of the heater body (that is, mounting surface of the heater body to the mounting base), good insulation can be ensured between the heater body and the cooling module by the insulating sheet and the protective layer, as the insulating sheet and the protective layer are interposed between the heater body and the cooling module. Further, the protective layer realizes satisfactory tight contact between the heater body and the cooling module or the like.

As a still another approach, the side opposite to the surface having the heating body formed thereon of the heater body obtained by forming the heating body on the insulating sheet, that is, the insulating sheet side, may be fixed on the mounting base using the adhesive layer, to provide the heater unit. In this case, the adhesive layer and the insulating sheet exist between the heating body and the mounting base, and therefore, good insulation can be ensured between the mounting base and the heating body. Here, on the surface opposite to the mounting surface to the mounting base of the heater body, the heating body is exposed, and therefore, in order to ensure insulation, it is preferred to form a protective layer further on the surface, on which the heating body is formed, of the heater body.

When the protective layer is formed on the side opposite to the mounting surface to the mounting base of the heater body as described above, it is preferred that the material of the protective layer is heat-resistant. Further, it is preferred that the material of the protective layer is the same as that of the adhesive layer in view of cost and because separation resulting from the difference in thermal expansion coefficient or the like can be prevented and high reliability can be attained.

The heater unit in accordance with the present invention including the mounting base for mounting the object to be processed and the heater body for heating the mounting base is preferably used as a heater unit for a wafer prober used for inspecting semiconductor wafers, that is, as a wafer heating unit. Recently, 8-inch wafers or 12-inch wafers come to be used as semiconductor wafers inspected by the wafer prober. The heater unit in accordance with the present invention may have a structure that can absorb the difference in thermal expansion coefficient between the heating body and the mounting base, by forming the adhesive layer, protective layer, insulating sheet and the like. This is particularly preferable as the unit can accommodate wafers of larger size. Further, the heater unit of the present invention is preferred as it can be obtained at a relatively low cost, as the heater unit used for the wafer prober.

A wafer heater unit as a typical embodiment of the heater unit in accordance with the present invention will be described in the following with reference to the figures, though the invention is not limited thereto.

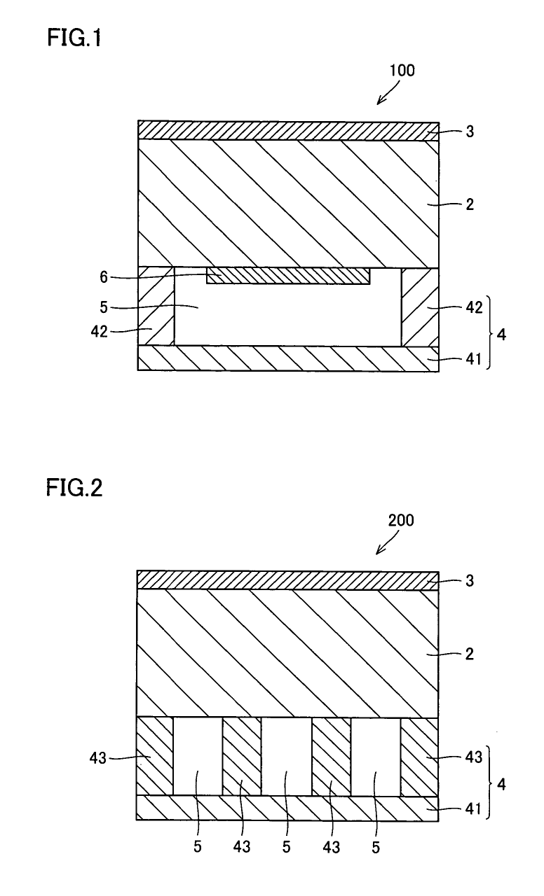

An example of the heater unit in accordance with the present invention will be described with reference to FIG. 1. In each of the figures of the present invention, members or portions denoted by the same reference characters denote the members or portions having similar functions, unless specified otherwise. Heater unit 100 in accordance with the present invention includes a chuck top 2 having a chuck top conductive layer 3 as the mounting base for mounting the object to be processed, a supporter 4 supporting chuck top 2, and a heater body 6. Heater body 6 has an insulating sheet and a heating body formed on the insulating sheet. Further, supporter 4 is mounted on a driving system (not shown) for moving the heater unit 100 as a whole.

It is preferred that supporter 4 has Young's modulus of at least 200 GPa. In this case, deformation of supporter 4 itself can be made small, and hence, deformation of chuck top 2 can further be suppressed. More preferable Young's modulus of supporter 4 is at least 300 GPa. Young's modulus of supporter 4 of 300 GPa or higher is particularly preferred, as deformation of supporter 4 can significantly be reduced and hence supporter 4 can further be reduced in size and weight.

In the present invention, Young's modulus may be measured, for example, by the pulse method or the flexural resonance method.

As to the shape of supporter 4, the shape having a base portion 41 and a circular tube portion such as shown in FIG. 1 is preferably used. Alternatively, provision of a plurality of pillars 43 such as shown in a heater unit 200 of FIG. 2 is preferred. By the provision of circular tube portion 42 or pillars 43, it follows that most of the volume of supporter 4 is occupied by a space 5. Therefore, heat transfer path from chuck top 2 through supporter 4 to the driving system of the heater unit becomes narrow, and temperature increase in the driving system can be prevented while rigidity of supporter 4 can be maintained and there is no adverse influence on suppressing deformation of the chuck top.

Supporter 4 preferably has thermal conductivity of at most 40 W/mK. Then, the amount of heat transferred from chuck top 2 through supporter 4 to the driving system of the heater unit is further reduced, and temperature increase of the driving system can effectively be prevented. Recently, a temperature as high as 150° C. is required at the time of probing, and therefore, it is more preferred that supporter 4 has thermal conductivity of at most 10 W/mK. More preferable thermal conductivity is at most 5 W/mK. With the thermal conductivity of this range, the amount of heat transfer from supporter 4 to the driving system decreases significantly.

In the present invention, the thermal conductivity may be measured by a method such as laser flash method, using pelletized samples.

As a material having good flatness, allowing processing to the shape as described above and having Young's modulus and thermal conductivity as described above as physical properties, mullite, alumina or a composite material of mullite and alumina is preferred, considering processability and cost.

When chuck top 2 is heated by heater body 6 and the wafer is inspected, for example, at 200° C., it is preferred that the temperature at the bottom surface of supporter 4 is at most 100° C. When the temperature exceeds 100° C., contact failure possibly occurs because of thermal expansion of the driving system of the heater unit, and when inspection is to be done at a room temperature after inspecting the wafer at 200° C., cooling takes long time and hence, throughput would be decreased.

When supporter 4 includes a circular tube portion 42, it is preferred that the radial thickness of circular tube portion 42 is at most 20 mm. When the radial thickness exceeds 20 mm, the amount of heat transferred from chuck top 2 through supporter 4 to the driving system of heater unit may possibly increase. When the radial thickness is smaller than 1 mm, supporter 4 itself tends to be deformed or damaged by the load of the probe card, and therefore, it is preferred that the radial thickness is at least 1 mm.

When supporter 4 includes circular tube portion 42, it is preferred that the height of circular tube portion 42 is at least 10 mm. When the height of circular tube portion 42 is lower than 10 mm, the amount of heat transferred from chuck top 2 through supporter 4 to the driving system of heater unit may possibly increase.

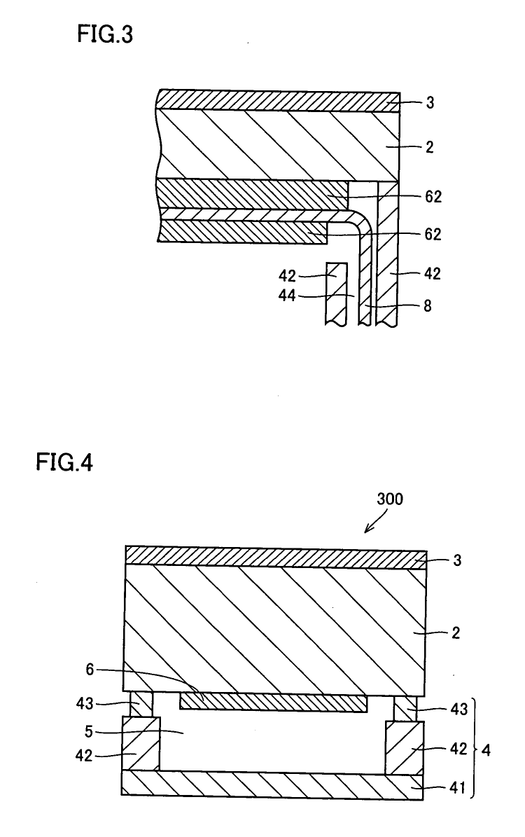

FIG. 3 shows, in enlargement, a contact portion between chuck top 2 and circular tube portion 42, when supporter 4 has circular tube portion 42. It is preferred that at circular tube portion 42 of supporter 4, a through hole 44 is formed for inserting an electrode line 8 for feeding power to heater body 62 or an electrode line for electromagnetic shield, as such structure facilitates handling of the electrode line. Here, the position for forming through hole 44 is preferably close to an inner circumferential surface of the circular tube portion 42, as the decrease in strength of circular tube portion 42 can be minimized. It is noted that the electrode line and the through hole are not shown in figures other than FIG. 3, for the purpose of simplicity.

It is preferred that the thickness of base portion 41 of supporter 4 is at least 10 mm. When the thickness of base portion 41 of supporter 4 is smaller than 10 mm, supporter 4 itself tends to be deformed or damaged by the load of the probe card. The base portion 41 of supporter 4 may be integrated with or separated from circular tube portion 42 or pillars 43 when pillars 43 such as shown in heater unit 200 of FIG. 2 are provided. When it is made separable, a contact interface comes to be formed between base portion 41 and circular tube portion 42 or pillar 43. The contact interface serves as thermal resistance, and therefore, it is preferred as the amount of heat transferred from chuck top 2 through supporter 4 to the driving system of the heater unit can be reduced.

When supporter 4 includes a plurality of pillars 43, it is preferred that 8 or more pillars 43 are provided in uniform, concentric arrangement or in a similar arrangement. Recently, wafer size has come to be increased to 8 to 12 inches, and therefore, if the number is smaller than 8, distance between pillars 43 to each other would be long, the function of supporting chuck top 2 when load is applied from the probe card degrades, and deformation of chuck top 2 becomes more likely. The shape of the pillars 43 may be a cylinder or it may be a triangular pole, a quadrangular pole or a polygonal pole with any polygon as a bottom surface, and its cross-sectional shape is not specifically limited.

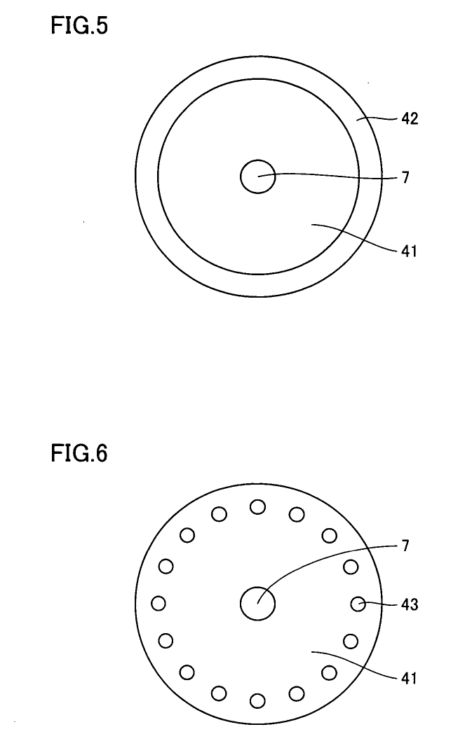

Supporter 4 may include both the circular tube portion 42 and the plurality of pillars 43, as shown in heater unit 300 of FIG. 4. Combination of these is preferred, as the amount of heat transferred to the driving system of the heater unit can be reduced without increasing deformation of supporter 4 and chuck top 2.

Surface roughness Ra of a contact surface between supporter 4 and chuck top 2 is preferably at least 0.1 μm, both at supporter 4 and chuck top 2. When the surface roughness Ra is at least 0.1 μm, thermal resistance at the contact surface between supporter 4 and chuck top 2 increases, and the amount of heat transferred to the driving system of the heater unit can be reduced. The upper limit of surface roughness Ra is not specifically limited. As for the method of realizing surface roughness Ra of at least 0.1 μm, polishing process or sand blasting may preferably used.

In the present invention, surface roughness Ra represents arithmetic mean deviation, of which detailed definition can be found, for example, in JIS B 0601.

In addition to the contact surface between supporter 4 and chuck top 2, the surface roughness Ra at the contact surface between the bottom surface of supporter 4 and the driving system, the contact surface between base portion 41 of supporter 4 and circular tube portion 42 or pillar 43 when base portion 41 of supporter 4 is made separable from circular tube portion 42 or pillar 43, and at the contact surface between circular tube portion 42 and the plurality of pillars 43 when circular tube portion 42 and the plurality of pillars 43 are used in combination, should also be at least 0.1 μm as in the foregoing, because the thermal resistance is increased and the amount of heat transferred to the driving system of the heater unit can be reduced. Reduction in heat quantity transferred to the driving system, attained by the increased thermal resistance, leads to reduction of power supply to the heating body.

It is preferred that a metal layer is formed on the surface of supporter 4. Electric field or electromagnetic wave generated by heater body 6 heating chuck top 2, a prober driving unit or by peripheral apparatuses may affect wafer inspection as noise. Formation of the metal layer on supporter 4 is preferred, as it can intercept (shield) the electromagnetic wave. The method of forming the metal layer is not specifically limited. By way of example, a conductive paste prepared by adding glass frit to metal powder of silver, gold, nickel or copper may be applied using a brush and burned.

Alternatively, metal such as aluminum or nickel may be thermally sprayed to form the metal layer. The metal layer may be formed by plating on the surface. Further, combination of these methods is also possible. Specifically, metal such as nickel or the like may be plated after burning the conductive paste, or plating may be done after thermal spraying. Among these methods, plating is preferred, as it has high contact strength and is highly reliable. Further, thermal spraying is preferred as it allows formation of the metal film at a relatively low cost.

As another method, a conductor having a circular tube shape may be attached on a side surface of supporter 4. The material used here is not specifically limited, as long as it is a conductor. By way of example, metal foil or a metal plate of stainless steel, nickel, aluminum or the like may be formed to have a circular tube shape of a size larger than the outer diameter of supporter 4, and it may be attached on the side surface of supporter 4. Further, at the bottom surface portion of supporter 4, metal foil or a metal plate may be attached, and by connecting this to the metal foil or metal plate attached to the side surface of supporter 4, the effect of shielding the electromagnetic wave can be enhanced. Further, utilizing the space 5 inside supporter 4, the metal foil or metal plate may be attached inside the space 5, and by connecting this to the metal foil or metal plate attached to the side surface and the bottom surface of supporter 4, the effect of shielding the electromagnetic wave can be enhanced. Adopting the method of attaching metal foil or a metal plate is preferred, because the electromagnetic wave can be shielded at a lower cost than when plating is provided or a conductive paste is applied. Though the method of fixing the metal foil or the metal plate to supporter 4 is not specifically limited, the metal foil or metal plate may be attached to supporter 4 using, for example, metal screws. Further, the metal foil or the metal plates on the bottom surface and on the side surface may be integrated beforehand and then fixed on supporter 4.

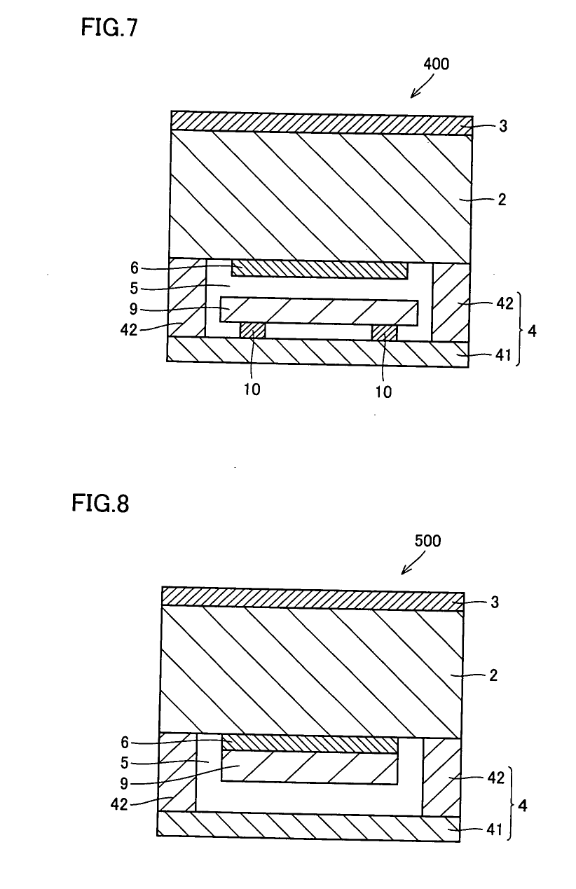

When supporter 4 includes circular tube portion 42 or a plurality of pillars 43 as shown in FIGS. 5 and 6, it is preferred that a support rod 7 is provided near the central portion of supporter 4. Support rod 7 can further suppress deformation of chuck top 2 when load is applied by the probe card. It is preferred that the material of support rod 7 is the same as that of circular tube portion 42 or pillar 43. When circular tube portion 42 or pillar 43 and support rod 7 thermally expand because of the heat from heater body 6 and the materials are different, a step would be generated between circular tube portion 42 or pillar 43 and support rod 7, because of the difference in thermal expansion coefficient. As to the size of support rod 7, it is preferred that the radial cross-sectional area is at least 0.1 cm². When the cross-sectional area is smaller than 0.1 cm², satisfactory supporting effect would not be attained, and support rod 7 tends to deform. The cross-sectional area should preferably be at most 100 cm². When the cross-sectional area exceeds 100 cm², the amount of heat transferred to the driving system tends to increase.

The shape of support rod 7 is not specifically limited, and it may be a cylinder, triangular pole, a quadrangular pole or the like. The method of fixing support rod 7 to supporter 4 is not specifically limited, and methods such as brazing with an active metal, glass fixing, or screw fixing may be used, and among these methods, screw fixing is particularly preferred. Screw fixing facilitates attachment/detachment, and as heat treatment is not necessary at the time of fixing, deformation of supporter 4 or support rod 7 by the heat treatment can be avoided.

It is preferred that the electromagnetic shield layer for shielding the electromagnetic wave is also formed between heater body 6 heating chuck top 2 and chuck top 2. For forming the electromagnetic shield layer, the method of forming a metal layer on the surface of supporter 4 such as described above may be used, and, by way of example, metal foil may be inserted between heater body 6 and chuck top 2. The material of metal foil to be used is not specifically limited, and foil of stainless steel, nickel or aluminum may be used.

Further, it is preferred that an insulating layer is provided between the electromagnetic shield layer and chuck top 2. The insulating layer serves to cut off noise that affects inspection of the wafer, such as the electromagnetic wave or electric field generated at heater body 6 and the like. The noise particularly has significant influence on measurement of high-frequency characteristics of the wafer, and the noise does not have much influence on the measurement of normal electric characteristics. Though most of the noise generated at the heater body 6 is shielded by the electromagnetic shield layer, in terms of electric circuit, a capacitor is formed between chuck top conductive layer 3 formed on the wafer-mounting surface of chuck top 2 and the electromagnetic shield layer when chuck top 2 is an insulator, or between chuck top 2 itself and heater body 6 when chuck top 2 is a conductor, and the capacitor may have an influence as a noise at the time of inspecting the wafer. In order to reduce the influence, the insulating layer may be formed between the electromagnetic shield layer and chuck top 2.

Further, it is preferred that a guard electrode layer is formed between chuck top 2 and the electromagnetic shield layer with an insulating layer interposed. By connecting the guard electrode layer to the metal layer formed on supporter 4, the noise that affects measurement of high-frequency characteristic of the wafer can further be reduced. Specifically, in the present invention, when supporter 4 as a whole including heater body 6 is covered by a conductor, the influence of noise at the time of measuring wafer characteristics at a high frequency can be reduced. When the guard electrode layer is connected to the metal layer provided on supporter 4, the influence of noise can further be reduced.

At this time, it is preferred that the resistance value of the insulating layer is at least 1×10⁷Ω. When the resistance value is smaller than 1×10⁷Ω, small current flows to chuck top conductive layer 3 because of the influence of heater body 6, which small current possibly becomes noise at the time of probing and affects probing. When the resistance value of the insulating layer is at least 1×10⁷Ω, the small current can sufficiently be reduced not to affect probing. Recently, circuit patterns formed on wafers have been miniaturized, and therefore, it is preferable to reduce such noise as much as possible. When the resistance value of the insulating layer is at least 1×10¹⁰Ω, reliability can further be enhanced.

Further, it is preferred that the dielectric constant of the insulating layer is at most 10. When the dielectric constant of the insulating layer exceeds 10, charges tend to be stored more easily at the electromagnetic shield layer sandwiching the insulating layer, the guard electrode layer and chuck top 2, which might possibly be a cause of noise generation. Particularly, as the wafer circuits have been much miniaturized in these days as described above, it is preferable to reduce noise, and therefore, dielectric constant should preferably be at most 4 and more preferably at most 2. Setting small the dielectric constant of the insulating layer is preferred, as the thickness of the insulating layer necessary for ensuring the insulation resistance value and the capacitance described above can be made thinner, and hence, thermal resistance posed by the insulating layer can be reduced.

Further, when chuck top 2 is an insulator, capacitance between chuck top conductive layer 3 and the guard electrode layer and between chuck top conductive layer 3 and the electromagnetic shield layer, or when chuck top 2 is a conductor, the capacitance between chuck top 2 itself and the guard electrode layer and between chuck top 2 itself and the electromagnetic shield layer, should preferably be at most 5000 pF. When the capacitance exceeds 5000 pF, the influence of the insulating layer as a capacitor would be too large, possibly causing noise and affecting probing. Capacitance of at most 1000 pF is preferred, as it enables inspection free of noise influence of even a miniaturized circuitry.

As described above, by controlling the resistance value, dielectric constant and capacitance of the insulating layer in the ranges described above, noise at the time of inspection can significantly be reduced.

The thickness of the insulating layer should preferably be at least 0.2 mm. In order to reduce the size of the device and to maintain good heat conduction from heater body 6 to chuck top 2, the thickness of the insulating layer should be small. When the thickness of the insulating layer is smaller than 0.2 mm, however, defects in the insulating layer itself or problems in durability would be generated. It is more preferred that the thickness of the insulating layer is at least 1 mm, because such a thickness prevents the problem of durability and ensures good heat conduction from the heater body 6. The thickness of the insulating layer is preferably at most 10 mm. When the thickness exceeds 10 mm, though the noise cutting effect is good, the time of conduction of heat generated by heater body 6 to chuck top 2 and to the wafer becomes too long, and hence, it possibly becomes difficult to control the heating temperature. Though it depends on the conditions of inspection, the thickness of the insulating layer of at most 5 mm is particularly preferred, as temperature control is relatively easy.

The thermal conductivity of the insulating layer is preferably at least 0.5 W/mK, as it realizes good heat conduction from heater body 6 as described above. Thermal conductivity of at least 1 W/mK is preferred, as heat conduction is further improved.

As the material for the insulating layer, one that has the characteristics described above and has heat resistance sufficient to withstand the inspection temperature may preferably be used, and ceramics or resin may be available. Filler may be dispersed in the resin. Of these, resin such as silicone resin or the silicone resin having filler dispersed therein, and ceramics such as alumina, may preferably be used. The filler dispersed in the resin serves to improve heat conduction of the resin. Any material having no reactivity to the resin may be used as the filler, and by way of example, substances such as boron nitride, aluminum nitride, alumina and silica may be available.

Further, it is preferred that the area for forming the insulating layer is the same or larger than the area for forming the electromagnetic shield layer, the guard electrode or heater body 6. When the area for forming the insulating layer is smaller than the area for forming the electromagnetic shield layer, the guard electrode or heater body 6, noise may possibly enter from a portion not covered with the insulating layer.

A specific example of the insulating layer will be described in the following. In the following, an example will be described in which silicone resin having boron nitride dispersed therein is used as the material of the insulating layer. The material has thermal conductivity of about 5 W/mK, and dielectric constant of 2. When the silicone resin with boron nitride dispersed is inserted as the insulating layer between the electromagnetic shield layer and chuck top 2, and chuck top 2 corresponds to a 12-inch wafer, it may be formed, for example, to have the diameter of 300 mm. Here, when the thickness of the insulating layer is set to 0.25 mm, capacitance of 5000 pF can be attained. When the thickness is set to 1.25 mm or more, capacitance of 1000 pF or lower can be attained. Volume resistivity of the insulating layer is 9×10¹⁵ Ω·cm, and therefore, when the diameter is 300 mm and the thickness is made at least 0.8 mm, the resistance value of at least 1×10¹²Ω can be attained. Therefore, when the thickness of the insulating layer is made at least 1.25 mm, an insulating layer having sufficiently low capacitance and sufficiently high resistance value can be obtained.

It is preferred that warp of chuck top 2 is at most 30 μm. When the warp exceeds 30 μm, contact with a needle of the probe card may possibly be biased at the time of inspection, resulting in a contact failure. Similarly, if the parallelism between the surface of the chuck top conductive layer 3 and the rear surface at the bottom portion of supporter 4 exceeds 30 μm, the contact failure possibly occurs. It is preferred that warp and parallelism described above are at most 30 μm not only at the room temperature but in the temperature range of −70° C. to 200° C., in which probing is typically done.

The warp and parallelism may be measured using, for example, a three-dimensional measuring apparatus.

Chuck top conductive layer 3 formed on the wafer-mounting surface of chuck top 2 has a function of a ground electrode and, in addition, has the function of protecting chuck top 2 from corrosive gas, acid, alkali chemical, organic solvent or water.

Possible methods of forming chuck top conductive layer 3 include a method in which a conductive paste is applied by screen printing and then fired, vapor deposition or sputtering, thermal spraying and plating. Among these, thermal spraying and plating are particularly preferred. These methods do not involve heat treatment at the time of forming the conductive layer, and therefore, warp of chuck top 2 caused by heat treatment can be avoided and the conductive layer can be formed at a low cost.

Particularly, a method of forming a thermally sprayed film on chuck top 2 and then forming a plating film further thereon is preferred. The material thermally sprayed (aluminum, nickel or the like) forms some compound such as oxide, nitride or oxynitride at the time of thermal spraying, and such compound reacts to the surface of chuck top 2, realizing firm contact. The thermally sprayed film, however, has low electric conductivity because it contains the compound mentioned above. In contrast, plating forms an almost pure metal film, and therefore, a conductive layer of superior electric conductivity can be formed, though contact strength of a plated film with the surface of chuck top 2 is not as high as that of the thermally sprayed film. The thermally sprayed film and the plated film both contain metal as the main component and, therefore, contact strength therebetween is high. Therefore, by forming the thermally sprayed film as a base and forming plated film thereon, chuck top conductive layer 3 having both high contact strength and high electric conductivity can be provided.

It is preferred that surface roughness Ra of chuck top conductive layer 3 is at most 0.5 μm. When the surface roughness Ra exceeds 0.5 μm and a device having a high calorific value is inspected, the heat generated from the device itself cannot be radiated from chuck top 2, and the device might possibly be broken by the heat. Surface roughness Ra of at most 0.02 μm is preferred, as more efficient heat radiation becomes possible.

Further, it is preferred that the thickness of chuck top 2 is at least 8 mm. When the thickness is smaller than 8 mm, chuck top 2 much deforms when load is applied at the time of inspection, possibly causing contact failure, and further causing damage to the wafer. It is more preferable that chuck top 2 has the thickness of at least 10 mm, as the possibility of contact failure can further be reduced.

It is preferred that chuck top 2 has Young's modulus of at least 250 GPa. When Young's modulus is smaller than 250 GPa, chuck top 2 much deforms when load is applied at the time of inspection, possibly causing contact failure, and further causing damage to the wafer. Young's modulus of chuck top 2 is preferably at least 250 GPa, and more preferably at least 300 GPa, as the possibility of contact failure can further be reduced.

Chuck top 2 preferably has thermal conductivity of at least 15 W/mK. When the thermal conductivity of chuck top 2 is lower than 15 W/mK, temperature uniformity of the wafer mounted on chuck top 2 would be deteriorated. When the thermal conductivity is not lower than 15 W/mK, thermal uniformity having no adverse influence on inspection can be attained. Thermal conductivity of 170 W/mK or higher is more preferable, as the thermal uniformity of the wafer can further be improved.

As the material having such Young's modulus and thermal conductivity as described above, various ceramics and metal-ceramics composite materials may be available. Preferred metal-ceramics composite material includes composite material of aluminum and silicon carbide (Al—SiC) and composite material of silicon and silicon carbide (Si—SiC), which have relatively high thermal conductivity and easily realize thermal uniformity when the wafer is heated. Of these, composite of silicon and silicon carbide (Si—SiC) is particularly preferred, as it has high thermal conductivity of 170 W/mK to 220 W/mK and high Young's modulus.

The composite materials described above are conductive and, therefore, as to the method of forming heater body 6, heater body 6 may be formed by forming an insulating layer through a method of thermal spraying or screen printing on a surface opposite to the wafer-mounting surface of chuck top 2, and by forming the conductive layer of the heating body in accordance with the present invention in a prescribed shape through a method such as screen printing or vapor deposition. Here, the insulating sheet of heater body 6 may be formed on the side facing chuck top 2 or on the opposite side.

Alternatively, metal foil of stainless steel, nickel, silver, molybdenum, tungsten, chromium and an alloy of these may be etched to form a prescribed pattern of heating body, to be the heating body of heater body 6. In this method, insulation from chuck top 2 may be attained by the method similar to that described above, or as the insulating sheet in the heater body is inserted between chuck top 2 and the heating body, the insulating sheet may be formed as the insulating layer. This is preferable, as the insulating layer can be formed at a considerably lower cost and in a simpler manner than the method described above. Resin that can be used as the insulating layer includes, from the viewpoint of heat resistance, mica sheet, epoxy resin, polyimide resin, phenol resin and silicone resin. Among these, mica is particularly preferable, as it has superior heat resistance and electric insulation, allows easy processing and is inexpensive.

Use of ceramics as the material for chuck top 2 is advantageous in that formation of an insulating layer between chuck top 2 and the heating body is unnecessary. Among ceramics, alumina, aluminum nitride, silicon nitride, mullite, and a composite material of alumina and mullite are preferred as they have relatively high Young's modulus and hence, not much deformed by the load of the probe card. Among these, alumina is preferred as it is relatively inexpensive and has superior insulation at a high temperature. Generally, at the time of sintering, in order to lower sintering temperature, an oxide of alkali-earth metal, silicon or the like is added to alumina. If the amount of addition is reduced and purity of alumina is increased, insulation can further be improved, though the cost increases. With the purity of at least 99.6%, high insulation can be attained, and with the purity of at least 99.9%, particularly high insulation can be attained. Further, as the purity increases, alumina comes to have higher insulation and, at the same time, higher thermal conductivity, and with the purity of 99.5%, thermal conductivity of 30 W/mK can be attained. Purity of alumina may appropriately be selected in consideration of insulation, thermal conductivity and cost. Aluminum nitride is preferred as it has particularly high thermal conductivity of 170 W/mK.

As the material of chuck top 2, metal may be applied. In that case, tungsten, molybdenum or an alloy of these having particularly high Young's modulus may be used. Specific alloy may include an alloy of tungsten and copper and an alloy of molybdenum and copper. Such an alloy can be fabricated by impregnating tungsten or molybdenum with copper. Similar to the metal-ceramics composite material described above, these metals are conductors and therefore, the above-described method can directly be applied, to form chuck top conductive layer 3 and further to form heater body 6.

It is preferred that chuck top 2 deflects at most by 30 μm when a load of 3.1 MPa is applied to chuck top 2. A large number of pins for inspecting the wafer press the wafer from the probe card to the chuck top 2, and therefore, the pressure also acts on chuck top 2, and chuck top 2 deflects to no small extent. When the amount of deflection at this time exceeds 30 μm, it becomes impossible to press the pins of the probe card uniformly onto the wafer, and inspection of the wafer might fail. More preferably, the amount of deflection when the load of 3.1 MPa is applied to chuck top 2 is at most 10 μm.

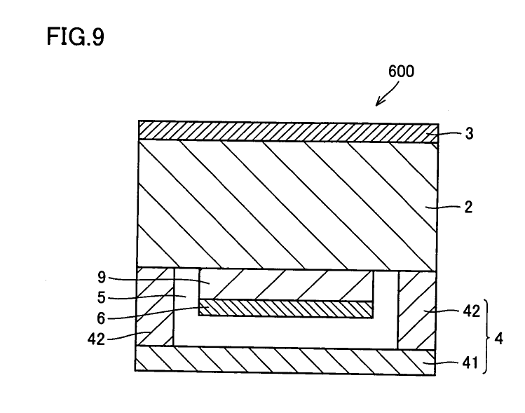

In the present invention, as shown in heater unit 400 of FIG. 7, a cooling module 9 may be provided in space 5 inside supporter 4. Provision of cooling module 9 is preferred, because when it becomes necessary to cool chuck top 2, chuck top 2 can be cooled rapidly as the heat is removed, and throughput can be improved.

As the material of cooling module 9, aluminum, copper and an alloy of these are preferred, because they have high thermal conductivity and capable of removing heat quickly from chuck top 2. It is also possible to use stainless steel, magnesium alloy, nickel or other metal materials. On a surface of cooling module 9, an oxidation-resistant metal film such as nickel, gold, silver or the like may be formed by the method of plating, thermal spraying or the like, to add oxidation resistance.

Alternatively, ceramics may be used as the material for cooling module 9. Among ceramics, aluminum nitride and silicon carbide are preferred as they have high thermal conductivity and are capable of removing heat quickly from chuck top 2. Further, silicon nitride and aluminum oxynitride are preferred, as they have high mechanical strength and superior durability. Oxide ceramics such as alumina, cordierite and steatite are preferred as they are relatively inexpensive. As described above, the material for cooling module 9 may be selected appropriately in consideration of the intended use, cost and the like. Among these materials, nickel-plated aluminum or nickel-plated copper is particularly preferred, as it has superior oxidation resistance and high thermal conductivity and is relatively inexpensive.

A coolant may be caused to flow in cooling module 9. Causing the coolant flow is preferred, as the heat transferred from chuck top 2 to cooling module 9 can quickly be removed and the cooling rate of chuck top 2 can be improved. Types of the coolant may be selected from liquid such as water, Fluorinert or Galden, or gas such as nitrogen, air or helium. When the temperature of use is always 0° C. or higher, water is preferred considering magnitude of specific heat and cost, and when it is cooled below zero, Galden is preferred considering specific heat.

As the method of forming the passage for the coolant flow, two plates may be prepared, for example, and the passage may be formed by machine processing on one of the plates. In order to improve corrosion resistance and oxidation resistance, entire surfaces of the two plates may be nickel-plated, and thereafter, the two plates may be joined by means of screws or welding. At this time, a sealing member such as an O-ring may be inserted around the passage, to prevent leakage of the coolant.

As another method of forming the flow passage, a pipe through which the coolant flows may be attached to a cooling plate. Here, in order to increase contact area between the cooling plate and the pipe, the cooling plate may be processed to have a trench of an approximately the same cross-sectional shape as the pipe and the pipe may be arranged in the trench, or a flat-shaped portion may be formed on a portion of the cross-sectional shape of the pipe and that flat portion may be fixed on the cooling plate. As to the method of fixing the cooling plate and the pipe, screw fixing using a metal band, welding or brazing may be available. By inserting a deformable substance such as resin between the cooling plate and the pipe, tight contact between the two is attained and cooling efficiency can be enhanced.

At the time of heating chuck top 2, if cooling module 9 can be separated from chuck top 2, efficient temperature elevation of chuck top 2 becomes possible, and therefore, it is preferred that cooling module 9 is movable. As a method of realizing mobile cooling module 9, an elevating mechanism 10 such as an air cylinder may be used. In this case, cooling module 9 does not bear the load of probe card, and therefore, it is free from the problem of deformation caused by the load.

When the cooling rate of chuck top 2 is of high importance, cooling module 9 may be fixed on chuck top 2. Specifically, as shown in a heating unit 500 of FIG. 8, heater body 6 may be provided on a side opposite to the wafer-mounting surface of chuck top 2, and cooling module 9 may be fixed on a lower surface thereof. As another arrangement, as shown in a heating unit 600 of FIG. 9, cooling module 9 may be directly provided on a surface opposite to the wafer-mounting surface of chuck top 2, and on a lower surface thereof, heater body 6 may be fixed. Here, it is also possible to insert a deformable and heat-resistant soft material having high thermal conductivity between the surface opposite to the wafer-mounting surface of chuck top 2 and cooling module 9. By providing the soft material between chuck top 2 and cooling module 9 that can moderate warp or parallelism of the two, it becomes possible to enlarge the contact area, and the original cooling performance of the cooling module 9 can more fully be exhibited, realizing higher cooling rate.

In any of the arrangements, the method of fixing chuck top 2, cooling module 9 and heater body 6 is not specifically limited, and by way of example, they may be fixed by a mechanical method such as screw fixing or clamping. When chuck top 2, cooling module 9 and heater body 6 are to be fixed together by screws, three or more screws are preferred as tight contact between each of the members can be improved, and six or more screws are more preferable.

Further, the cooling module may be mounted inside the space 5 of supporter 4, or the cooling module may be mounted on the supporter and the chuck top may be mounted thereon. No matter which method is adopted, when the chuck top and the cooling module are fixed together, cooling rate can be increased as compared with the movable example. When the cooling module is mounted on the supporter, contact area between the cooling module and the chuck top is increased, and it becomes possible to cool the chuck top in a shorter time period.

When cooling module 9 fixed on chuck top 2 can be cooled by a coolant, it is preferred that the flow of coolant to cooling module 9 is stopped when the temperature of chuck top 2 is increased or when it is kept at a high temperature, because the heat generated by heating body is not removed by the coolant, and whereby efficient temperature increase or maintenance of high temperature becomes possible. Naturally, chuck top 2 can be cooled efficiently by causing the coolant to flow again at the time of cooling.

Further, chuck top 2 itself may be formed as the cooling module, by providing a passage through which the coolant flows inside chuck top. In that case, the time for cooling can further be reduced than when the cooling module is fixed on the chuck top. As the material for the chuck top, ceramics and metal-ceramics composite material similar to the above may be used. As for the structure, for example, chuck top conductive layer 3 may be formed on one surface of a member I to be the wafer-mounting surface, and a passage for the coolant flow is formed on the opposite surface, and a member II may be integrated by brazing, glass fixing or screw fixing, on the surface having the passage formed thereon, whereby the chuck top integrated with the cooling module can be provided. Alternatively, a passage may be formed on one surface of member II, and the member may be integrated with member I on the surface having the passage formed thereon, or passages may be made both on members I and II, and the members may be integrated on the surfaces having the passages formed thereon. It is preferred that the difference in thermal conductivity of members I and II is as small as possible, and ideally, the members are preferably formed of the same material.

When the chuck top itself is formed as the cooling module, metal may be used as the material. Metal is advantageous as it is less expensive as compared with the ceramics or composite material of ceramics and metal and it allows easy processing so that formation of the passage is easier. However, it is susceptible to deformation under the load from the probe card, and therefore, a plate-shaped member may be provided for preventing deformation of the chuck top, as the plate for preventing deformation, on the side opposite to the wafer-mounting surface of the chuck top. It is preferred that the plate for preventing deformation has Young's modulus of at least 250 GPa, as in the case where ceramics or metal-ceramics composite material is used as the material for the chuck top.

As for the position of arranging the plate for preventing deformation, it may be housed in the space 5 formed in supporter 4, or it may be inserted between the chuck top and the supporter. Chuck top 2 and the plate for preventing deformation may be fixed by a mechanical method such as screw fixing, or may be fixed by brazing or glass fixing. Efficient heating and cooling is also possible when the chuck top integrated with the cooling module is used, by not causing coolant to flow through the cooling module when the chuck top is heated or kept at a high temperature and causing the coolant to flow only at the time of cooling, as in the example in which the cooling module is fixed on the chuck top.

When the material of chuck top 2 is metal, the chuck top conductive layer 3 may be newly formed on the wafer-mounting surface of chuck top 2, if it is the case that the chuck top material is much susceptible to oxidation or alteration, or it does not have sufficiently high electric conductivity. As the method of forming chuck top conductive layer 3, vapor deposition, sputtering, thermal spraying or plating may be used as in the foregoing.

In the structure in which the plate for preventing deformation is provided on chuck top 2 formed of metal, formation of the electromagnetic shield layer or the guard electrode layer similar to that described above may be possible. By way of example, on the surface opposite to the wafer-mounting surface of chuck top 2, an insulated heater body 6 may be provided and covered with a metal layer, and further, the guard electrode layer may be formed with an insulating layer interposed, and between the guard electrode layer and chuck top 2, an insulating layer may be formed. Further, the plate for preventing deformation may be arranged, and chuck top 2, heater body 6 and the plate for preventing deformation may be fixed integrally on chuck top 2.

The heater unit of the present invention may be combined with known components of driving system, prober and the like, to provide a wafer prober. Further, the heater unit of the present invention may be applicable to a handler apparatus or a tester apparatus, and allows inspection without contact failure even of a semiconductor having minute circuitry.

### EXAMPLES

### Example 1

Heater unit 100 shown in FIG. 1 was fabricated. As chuck top 2, an Si—SiC substrate having the diameter of 310 mm and the thickness of 15 mm was prepared. On one surface of the substrate, concentric trenches and through holes for vacuum chucking a wafer were formed, and nickel plating was applied as the chuck top conductive layer 3, to provide a wafer-mounting surface. Thereafter, the wafer-mounting surface was polished and finished to have the overall warp amount of 10 μm and the surface roughness Ra of 0.02 μm, and chuck top 2 was completed.

Then, mullite-alumina composite body of a pillar shape having the diameter of 310 mm and thickness of 40 mm was prepared as supporter 4. The chuck top side surface of supporter 4 was counter-bored to have the inner diameter of 290 mm and the depth of 20 mm. On chuck top 2, stainless steel foil insulated with mica was attached as the electromagnetic shield layer. Further, a through hole 44 was formed in supporter 4, for connecting an electrode line for feeding power to the heating body, in the form as shown in FIG. 3. Further, on the side surface and bottom surface of supporter 4, aluminum was thermally sprayed to form a metal layer.

As for the heater body 6, polyimide resin was applied to the thickness of 200 μm on stainless steel foil having the thickness of 50 μm, dried and cured at 250° C., so that a polyimide layer was formed as the insulating sheet on the stainless steel foil, and the stainless steel foil was etched to a pattern of the heating body, to provide the heating body. On the heating body, heat-resistant rubber as the protective layer was applied to the thickness of 200 μm, and using the protective layer as the adhesive layer, heater body 6 was pressure-bonded to the side opposite to the wafer-mounting surface of chuck top 2.

### Comparative Example 1

For comparison, a heating body pattern was formed by etching stainless steel foil having the thickness of 50 μm to provide the heating body, heat-resistant rubber as the protective layer was applied to the thickness of 200 μm on both surfaces of the heater body implemented by the heating body, and the resulting body was pressure-bonded to the side opposite to the wafer-mounting surface of chuck top 2.

Then, on supporter 4, chuck top 2 having the heater body 6 and the electromagnetic shield layer attached was mounted on supporter 4 for each of Example 1 and Comparative Example 1, and heating units were provided.

The heating body of the heating units was electrically conducted to heat the wafer to 150° C., and probing was done continuously. As a result, one having the heating body formed on the insulating sheet of polyimide resin had no problem in heating chuck top 2 and probing was successful, while one fabricated as a comparative example had the stainless steel foil disconnected in the heat-resistant rubber as the insulating sheet was not formed, and chuck top 2 could not be heated.

### Example 2

A chuck top 2 similar to that of Example 1 was prepared. As the heating body, one provided by adhering nichrome foil having the thickness of 50 μm using polyimide resin on a polyimide sheet as the insulating sheet, heat treating at 250° C. and etching was used. Contrary to Example 1, heat-resistant rubber as the protective layer was applied to the thickness of 100 μm on the surface of the polyimide sheet as the insulating sheet on which the heating body was not attached. On the side of the heating body, silicone resin was applied to the thickness of 100 μm as the protective layer. When the wafer was heated to 150° C. and probing was done in the similar manner as in Example 1, chuck top 2 could be heated and probing could be done in the similar manner as in Example 1.

### Example 3

Heater units similar to that of Example 1 except that the materials shown in Table 1 were used for the insulating sheet on which the heating body was adhered were fabricated. The results of probing conducted in the similar manner as Example 1 are shown in Table 1.

TABLE 1

| | | Pressure bonding to | |
|---|---|---|---|
| Material of | Thickness | chuck top | |
| insulating sheet | (μm) | (conduction) | Effect of probing |
| Polyimide | 10 | Partially | — |
| | | disconnected | |
| Polyimide | 20 | Good | Good |
| Polyimide | 100 | Good | Good |
| Polyimide | 300 | Good | Good |
| Polyimide | 500 | Good | Good |
| Polyimide | 1000 | Good | Good |
| Polyimide | 2000 | Good | Poor thermal |
| | | | response |
| Phenol | 10 | Partially | — |
| | | disconnected | |
| Phenol | 100 | Good | Good |
| Phenol | 2000 | Good | Poor thermal |
| | | | response |
| Epoxy | 10 | Partially | — |
| | | disconnected | |
| Epoxy | 100 | Good | Good |
| Epoxy | 2000 | Good | Poor thermal |
| | | | response |

From the foregoing, it can be understood that the suitable thickness of the insulating sheet is 20 to 1000 μm. Though the insulating sheet having the thickness of 2000 μm allowed satisfactory probing when the temperature was kept at a constant value for probing, thermal response was poor and it took long time when the temperature of chuck top 2 was changed.

### Example 4

The thickness of the polyimide sheet as the insulating sheet was set to 50 μm. The heating body was fabricated by applying polyimide thin on stainless steel foil, adhering it to the polyimide sheet, curing at 250° C. and etching. Heater units were fabricated in the similar manner as Example 1 except that protective layers of the materials shown in Table 2 were applied on the surfaces of the heat generating bodies and that the surface of the insulating sheet to which the protective layer was applied or the opposite surface was pressure-bonded to chuck top 2. The results of probing conducted in the similar manner as Example 1 are shown in Table 2.

TABLE 2

| | Thickness of | | |
|---|---|---|---|
| | protective | | |
| Material of protective | layer | | |
| layer | (μm) | Attached surface | Effect of probing |
| None | — | Heating body | x |
| Heat-resistant rubber | 5 | Heating body | Good (with some noise at high |
| | | | frequency) |
| Heat-resistant rubber | 20 | Heating body | Good (with some noise at high |
| | | | frequency) |
| Heat-resistant rubber | 50 | Heating body | Good |
| Heat-resistant rubber | 100 | Heating body | Good |
| Heat-resistant rubber | 300 | Heating body | Good |
| Heat-resistant rubber | 500 | Heating body | Good (slightly low thermal response) |
| None | — | Insulating sheet side | x |
| Heat-resistant rubber | 5 | Insulating sheet side | Good |
| Heat-resistant rubber | 20 | Insulating sheet side | Good |
| Heat-resistant rubber | 50 | Insulating sheet side | Good |
| Heat-resistant rubber | 100 | Insulating sheet side | Good |
| Heat-resistant rubber | 300 | Insulating sheet side | Good |
| Heat-resistant rubber | 500 | Insulating sheet side | Good (slightly low thermal response) |
| Silicone resin | 5 | Heating body | Good (with some noise at high |
| | | | frequency) |
| Silicone resin | 20 | Heating body | Good (with some noise at high |
| | | | frequency) |
| Silicone resin | 50 | Heating body | Good |
| Silicone resin | 100 | Heating body | Good |
| Silicone resin | 300 | Heating body | Good |
| Silicone resin | 500 | Heating body | Good (slightly low thermal response) |
| Silicone resin | 5 | Insulating sheet side | Good (with some noise at high |
| | | | frequency) |
| Silicone resin | 20 | Insulating sheet side | Good (with some noise at high |
| | | | frequency) |
| Silicone resin | 50 | Insulating sheet side | Good |
| Silicone resin | 100 | Insulating sheet side | Good |
| Silicone resin | 300 | Insulating sheet side | Good |
| Silicone resin | 500 | Insulating sheet side | Good (slightly low thermal response) |

From the foregoing, it can be understood that probing is possible when the thickness of the protective layer is at least 10 μm and at most 1 mm, and particularly successful probing is possible when the thickness is at least 50 μm and at most 300 μm.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A heater unit comprising a mounting base mounting an object of processing and a heater body heating said mounting base, wherein said heater body has an insulating sheet and a heating body formed on said insulating sheet.

2. The heater unit according to claim 1, wherein at least a part of said heating body is covered with a protective layer.

3. The heater unit according to claim 2, wherein material of said protective layer is heat-resistant rubber.

4. The heater unit according to claim 1, wherein material of said heating body is metal foil.

5. The heater unit according to claim 1, wherein material of said insulating sheet is heat-resistant resin.

6. The heater unit according to claim 1, implemented as a wafer heating unit.

7. A wafer prober comprising the heater unit according to claim 1.
